(19) United States
(12) Patent Application Publication
(10) Pub. No.: US 2018/0157975 A1
(43) Pub. Date: Jun. 7, 2018

(54) METHOD, SYSTEM AND COMPUTER PROGRAM FOR FORECASTING SIGNALING IN A LIGHT SIGNAL SYSTEM

(71) Applicant: SIEMENS AKTIENGESELLSCHAFT, Muenchen (DE)

(72) Inventors: DENIS PHILIPP HAHN, MUENCHEN (DE); DANIEL HOBOHM, MUENCHEN (DE)

(21) Appl. No.: 15/834,661

(22) Filed: Dec. 7, 2017

(30) Foreign Application Priority Data
Dec. 7, 2016 (DE) 102016224359.4

(51) Int. Cl. G06N 3/08; G08G 1/01

(52) U.S. Cl. CPC G06N 3/08; G08G 1/0129

(57) ABSTRACT

A system for forecasting a future signal pattern of a light signal system includes the following: A first communications interface for receiving traffic data for a light signal system, on the basis of which the light signal system can establish a future signal pattern, in order to display the signal pattern established; a second communications interface for receiving the signal pattern data of the light signal system corresponding to the signal pattern established by means of the light signal system; and a computing unit with artificial intelligence for forecasting a future signal pattern on the basis of the traffic data. The artificial intelligence is trainable on the basis of the traffic data and the signal pattern data of the light signal system. There is also provided a corresponding method, a computer program and a computer program product.

### CROSS-REFERENCE TO RELATED APPLICATION

This application claims the benefit, under 35 U.S.C. § 119, of German patent application DE 10 2016 224 359.4, filed Dec. 7, 2016; the prior application is herewith incorporated by reference in its entirety.

### BACKGROUND OF THE INVENTION

### Field of the Invention

The invention relates to a system for forecasting a future signal pattern of a light signal system. The invention further relates to a method for forecasting a future signal pattern of a light signal system. Moreover, the invention relates to a computer program and a computer program product.

The forecasting of signal patterns of light signal systems is known in literature under the formulation “Signal Phase and Timing.” The expression “Signal Phase and Timing” can also be represented by the acronym SPAT.

As a rule, each light signal system is based on individual planning and programming as well as supply, which establish an output (signal pattern) for each lane by means of programming in complex “if-then” relationships from existing information. The information is supplied, for example, by detectors which are arranged on a road. The programming languages used for this can change, depending on the light signal system. In addition each traffic node is usually planned individually and most are as a rule not to be compared with other traffic nodes.

Previously a full knowledge of programming of the light signal system thus had to be available inter alia in order to be able to make a sensible forecast about the next steps of the light signal system.

Published patent application US 2014/0277986 A1 describes a method for predicting a future signal pattern of a light signal system.

### SUMMARY OF THE INVENTION

It is an object of the invention to provide a forecasting process which overcomes the above-mentioned and other disadvantages of the heretofore-known devices and methods of this general type and which provides for an efficient concept for efficient forecasting of a future signal pattern of a light signal system.

With the foregoing and other objects in view there is provided, in accordance with the invention, a system for forecasting a future signal pattern of a light signal system, the system comprising:

a first communications interface for receiving traffic data for a light signal system, wherein the light signal system is enabled to establish a future signal pattern based on the traffic data, in order to display the signal pattern thus established;

a second communications interface for receiving corresponding signal pattern data of the light signal system from the signal pattern established by the light signal system; and

a computing unit containing a trainable artificial intelligence to be trained on a basis of the traffic data and the signal pattern data of the light signal system and for forecasting a future signal pattern based on the traffic data.

In other words, according to one aspect of the invention, there is a system for forecasting a future signal pattern of a light signal system which includes: a first communications interface for receipt of traffic data for a light signal system, on the basis of which the light signal system can establish a future signal pattern, in order to display the signal pattern established, a second communications interface for receipt of the signal pattern data of the light signal system corresponding to the signal pattern established by means of the light signal system, and a computing unit comprising an artificial intelligence trainable on the basis of the traffic data and the signal pattern data of the light signal system for forecasting a future signal pattern on the basis of the traffic data.

With the above and other objects in view there is also provided, in accordance with the invention, a method for forecasting a future signal pattern of a light signal system. The method comprising the following steps:

receipt of traffic data for a light signal system, on the basis of which the light signal system can establish a future signal pattern, in order to display the signal pattern established,

receipt of the signal pattern data corresponding to the signal pattern of the light signal system established by means of the light signal system,

forecasting of a future signal pattern on the basis of the traffic data by means of a computing unit comprising an artificial intelligence,

wherein the artificial intelligence will be trained on the basis of the traffic data and the signal pattern data of the light signal system.

In accordance with a further aspect, a computer program is provided, which comprises program code for carrying out the method for forecasting a future signal pattern of a light signal system when the computer program is executed on a computer, in particular on a computing unit comprising an artificial intelligence.

The invention is based on the knowledge that the above object can be achieved by an artificial intelligence being used, in order, on the basis of the traffic data, to forecast a future signal pattern of a light signal system. The artificial intelligence will be trained here using the traffic data as well as signal pattern data, wherein this signal pattern data corresponds to a signal pattern established by means of the light signal system based on the same traffic data.

This thus means in particular that the artificial intelligence is trained by the traffic data on the one hand and by the signal pattern data of the light signal system on the other being used as input variables.

The artificial intelligence thus obtains the same traffic data as the light signal system. As part of the training the forecast future signal pattern will then be compared for example with the signal pattern that was established by means of the light signal system using the traffic data. Thus the artificial intelligence can learn over time in an advantageous manner how the light signal system establishes the future signal pattern based on the traffic data.

It is thus made possible in an advantageous manner to forecast the future signal pattern of the light signal system without any precise knowledge of the programming and planning of the light signal system being required in order to do so.

The inventive concept thus needs no knowledge of the precise way in which the light signal system functions. The concept merely provides for the same traffic data to be made available to the artificial intelligence as to the light signal system. The concept further provides for an output of the light signal system, i.e. the signal pattern established, to also be made available to the artificial intelligence, in order to train the latter, so that it can learn the behavior of the light signal system, in order to be able to make a forecast of the future signal pattern through this.

Thus the particular technical effect achieved by this is that an efficient concept for efficient forecasting of a future signal pattern of a light signal system is provided.

The concept thus makes it possible, in an advantageous manner, to forecast a signaling of a light signal system in road traffic by means of an artificial intelligence.

Traffic data in the sense of the description describes a traffic state for example. Traffic data in the sense of the description for example comprises detector data of one or more detectors for detecting traffic. Such detectors are arranged on, above or in a lane for example and count motor vehicles for example.

Traffic data in the sense of the description thus in particular comprises all data that the light signal system obtains in order to establish a future signal pattern on the basis of this data, which will then also be actually displayed by means of the light signal system.

An artificial intelligence in the sense of the description respectively comprises methods or processes from information technology respectively for example, which make the automation of intelligent behavior possible for example. The methods of artificial intelligence are characterized inter alia for example by making possible the capability of learning, using mathematical means, and also by the capability of dealing with uncertainty and probabilistic information. Some of the following methods are ascribed to artificial intelligence for example: Machine learning, deep learning, neural networks, knowledge inheritance, knowledge representation, cognition models, heuristic searching, speech processing. A plurality of AI (Artificial Intelligence) programming languages and so-called frameworks are also available for the different methods of artificial intelligence, which make it possible for the user to use so-called software libraries and then execute them for example at cloud-based computer centers. These include systems such as IBM Watson®, Google® TensorFlow® and Microsoft® Azure™ for example.

In accordance with one form of embodiment of the system there is provision for the artificial intelligence to have a signal pattern forecasting model, wherein the artificial intelligence is embodied, on the basis of the signal pattern forecasting model, to forecast the future signal pattern using the traffic data.

In one form of embodiment of the system there is provision for the computing unit or the artificial intelligence respectively to be embodied to train the signal pattern forecasting model on the basis of the traffic data and the signal pattern data of the light signal system.

In accordance with one form of embodiment of the system there is provision for the artificial intelligence to comprise a neural network.

The technical benefit achieved by this for example is that the future signal pattern can be efficiently forecast.

In accordance with one form of embodiment of the system there is provision for a machine-learning algorithm to be implemented in the artificial intelligence.

The technical benefit achieved by this for example is that the future signal pattern can be efficiently forecast. Also for example the technical benefit is achieved that the system can be applied to a plurality of control devices of light signal systems, since it does not need any manufacturer-specific and/or method-specific data. Above and beyond this the benefit achieved by this is that, once configured, the system improves continuously and can adapt to new situations without any corrective intervention into the forecasting algorithm.

In accordance with one form of embodiment of the system there is provision for the artificial intelligence to be part of a Cloud infrastructure.

The technical benefit achieved by this for example is that the artificial intelligence can be trained efficiently. In particular the technical benefit achieved by this is that the future signal pattern can be forecast efficiently.

For example companies such as Google with their TensorFlow framework or Microsoft with their Azure ML framework or IBM with their Watson framework make available artificial intelligences, on which for example models can be trained and applied using neural networks.

In one form of embodiment the system further comprises a third communications interface for sending signal pattern data corresponding to the forecast signal pattern over a communication network to a network address.

The technical benefit achieved by this for example is that the forecast signal pattern can be made available efficiently over a communication network.

The network address is for example the network address of a server.

The network address is for example the network address of a terminal, for example of a mobile terminal. The mobile terminal is for example a mobile telephone.

For example the terminal is part of a motor vehicle. This thus means for example that the signal pattern data corresponding to the forecast signal pattern is sent to a motor vehicle over a communication network.

A communication network in the sense of the description comprises a wired and/or a wireless communication network for example.

In one form of embodiment of the method the artificial intelligence comprises a neural network.

In one form of embodiment of the method a machine-learning algorithm is implemented in the artificial intelligence.

In one form of embodiment of the method the artificial intelligence is part of a Cloud infrastructure.

In one form of embodiment the method further comprises sending of the signal pattern data corresponding to the forecast signal pattern to a network address over a communication network.

According to one form of embodiment of the method there is provision for the artificial intelligence to have a signal pattern forecasting model, on the basis of which the future signal pattern is forecast using the traffic data.

The signal pattern forecasting model is trained, according to one form of embodiment of the method, on the basis of the traffic data and the signal pattern data of the light signal system.

According to one form of embodiment there is provision for the method for forecasting a future signal pattern of a light signal system to be executed or carried out by means of the system for forecasting a future signal pattern of a light signal system.

According to one form of embodiment the system for forecasting a future signal pattern of a light signal system is embodied or configured to execute or carry out the method for forecasting a future signal pattern of a light signal system.

Technical functionalities of the system for forecasting a future signal pattern of a light signal system are analogously produced directly from corresponding technical functionalities of the method for forecasting a future signal pattern of a light signal system and vice versa.

This thus means in particular that system features are produced directly from corresponding method features and vice versa.

Statements that are made in conjunction with the system apply analogously for the method and vice versa.

The formulation “or . . . respectively” in particular includes the formulation “and/or”.

In one form of embodiment the light signal system is logically linked to a number of detectors. In one form of embodiment there is provision for the system for forecasting a future signal pattern of a light signal system to be logically linked to the same detectors as the light signal system.

The forecasting of a future signal pattern comprises in particular the forecasting of a time of a beginning of a green phase or a beginning of a red phase respectively.

The forecasting of a future signal pattern comprises in particular the forecasting of a time of an end of a green phase or an end of a red phase respectively.

In accordance with one exemplary embodiment, a plurality of neural networks are provided. Statements that are made in conjunction with a neural network apply analogously for a number of neural networks and vice versa. This means in particular that when “neural network” is in the singular, the reader should always take this to include the plural as well and vice versa.

In one form of embodiment there is provision of the signal pattern forecasting model to be trained in a Cloud infrastructure. The Cloud infrastructure comprises for example a processor that is embodied to train the signal pattern forecasting model.

The training in the Cloud infrastructure has the particular advantage that sufficient processing capacity can be provided efficiently here in order to be able to train the signal pattern forecasting model efficiently.

In one form of embodiment the computing unit comprises a local computing unit. Local in this context means that the local computing unit is connected on site to the light signal system.

In accordance with one form of embodiment the local computing unit is embodied to train the signal pattern forecasting model. The local computing unit thus trains the signal pattern forecasting model in particular.

The training by means of a local computing unit has the particular advantage that the signal pattern forecasting model can be trained independently of remote servers or computers.

A local computing unit is a “PicoBox” or a Raspberry pi® for example.

Where the signal pattern forecasting model is trained in the Cloud infrastructure, there is provision in accordance with one form of embodiment, after the training, for the trained signal pattern forecasting model to be sent to the local computing unit over a communication network, which can also be referred to as the model being “deployed.”

Then for example, based on the trained signal pattern forecasting model sent, the forecast of the future signal pattern is carried out, which is updated second-by-second for example, by means of the local computing unit in particular in real time on the basis of the traffic data and for example on the basis of the signal status data.

For the formation of a forecast by means of the local computing unit on the basis of a trained signal pattern forecasting model provided by the Cloud infrastructure, usually only a little more computing power will be needed compared to the training. The technical benefit achieved by this is that the future signal pattern can be forecast efficiently and rapidly.

In one form of embodiment there is provision for traffic data and/or signal pattern data and/or corresponding signal pattern data from the forecast signal pattern to be sent by means of the local computing unit (for example PicoBox) into the Cloud infrastructure (which can also be referred to as a central computing unit), so that the Cloud infrastructure can train the signal pattern forecasting model on the basis of this data, in particular continuously.

As soon as the signal pattern forecasting model has been trained to the extent that a forecasting accuracy has been increased, there is provision in accordance with one form of embodiment for the trained signal pattern forecasting model to be sent back again to the local computing unit. In an advantageous manner a self-contained, adaptive self-improving system (local computing unit and central computing unit) is formed in this way.

Thus, in accordance with one form of embodiment, the computing unit comprises a local computing unit and a central computing unit. The local computing unit is connected to a control facility, for example to a control device, of the light signal system. The central computing unit is part of a Cloud infrastructure or is the Cloud infrastructure.

The central computing unit trains the artificial intelligence for example, in particular the central computing unit trains the signal pattern forecasting model. The central computing unit sends the trained signal pattern forecasting model to the local computing unit over a communication network.

The local computing unit forecasts the future signal pattern using the trained signal pattern forecasting model of the central computing unit, as described above and below.

For communication, i.e. in particular for the sending or receiving respectively of the (trained) signal pattern forecasting model, the local computing unit and the central computing unit in particular each have a communications interface.

The central computing unit can also be referred to as a remote computing unit, provided said unit, by contrast with the local computing unit, is not connected locally, i.e. on site, to the light signal system, i.e. in particular to the control facility of the light signal system.

The training, in particular the training of the signal pattern forecasting model, is carried out in accordance with one form of embodiment in addition to the traffic data and in addition to the signal pattern data on the basis of process data. Process data is for example or comprises for example: User parameters from the control logic of the light signal system and/or wireless telegrams for bus prioritization from a control device of the light signal system.

A neural network in the sense of the description refers for example to a software-side architecture for autonomous learning. A neural network is thus basically similar to the neural network of a child. Neural networks are thus for example a variant of artificial intelligence.

Training in the sense of the description can also be referred to as “learning”, which is also known as deep learning.

Deep Learning refers to a class of optimization methods of artificial neural networks, which in each case have a number of hidden layers between an input layer (here in particular the traffic data) and an output layer (here in particular the signal pattern data) and thereby have a comprehensive internal structure. As an expansion to the learning algorithms for network structures with very few or no hidden layers, such as for example in the single-layer perceptron, the methods of deep learning make possible a stable learning success even with a number of hidden layers.

The training is carried out in accordance with one form of embodiment in a Cloud infrastructure, which however only represents one form of embodiment and is thus not absolutely necessary.

The Cloud infrastructure is thus merely an example for a possibility of training the signal pattern forecasting model.

The signal pattern forecasting model is trained in accordance with a further form of embodiment by means of a locally installed computing unit.

In another form of embodiment there is provision for the signal pattern forecasting model to be trained by means of a communication network. The use of a processing power of a communication network is known as such under the term “edge computing.” In “edge computing” the processing power is namely no longer supplied by a Cloud infrastructure or by a local computing unit, but “at the edge” of a network, the communication network. Thus for example there is provision for processing power for training the signal pattern forecasting model to be provided by means of a radio tower of the telecommunications services operator. The corresponding processing power can be leased from the telecommunications services operator for example.

A communication network, which is used for edge computing for example, is for example an LTE 5G network. In edge computing the signal pattern forecasting model is thus no longer trained for example locally or on a remote server, but in a regionally restricted network.

A local computing unit, such as for example a Picobox, is thus used in particular in accordance with one form of embodiment so that the forecast can be created locally without latencies. Should there be a very stable communication option to a Cloud infrastructure available, it is not absolutely necessary for the forecast to be carried out locally by a local computing unit, such as for example a Picobox or a Raspberry pi, but in this respect this is a sensible and preferred form of embodiment in so far as no communication connection to a Cloud infrastructure is needed for the local creation of the forecast.

In accordance with one form of embodiment there is provision for the creation of the forecast to be carried out in a Cloud infrastructure or by means of a communication network (edge computing) respectively.

Other features which are considered as characteristic for the invention are set forth in the appended claims.

Although the invention is illustrated and described herein as embodied in a method and device using artificial intelligence to forecast signaling in a light signal system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a system for forecasting a future signal pattern of a light signal system; and

FIG. 2 shows a flow diagram of a method for forecasting a future signal pattern of a light signal system.

### DETAILED DESCRIPTION OF THE INVENTION

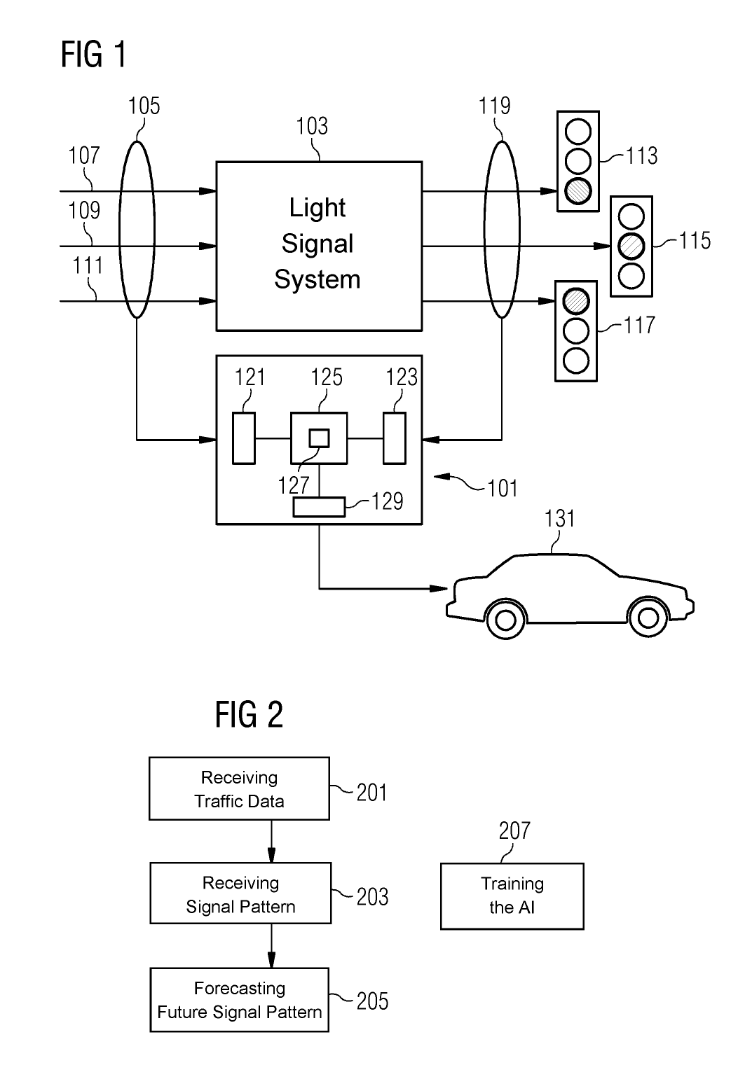

Referring now to the figures of the drawing in detail and first, particularly, to FIG. 1 thereof, there is shown a system 101 for forecasting a future signal pattern of a light signal system 103.

Traffic data 105 is provided to the light signal system 103. The traffic data 105 comprises detector data from three detectors, which is shown symbolically with three arrows with the reference numbers 107, 109 and 111.

On the basis of the traffic data 105 the light signal system 103 establishes a signal pattern for three signal groups 113, 115 and 117 in each case.

The signal pattern data corresponding to these signal patterns is shown symbolically as an ellipse with the reference numeral 119.

The system 101 comprises a first communications interface 121 for receiving the traffic data 105. The system 101 further comprises a second communications interface 123 for receiving the signal pattern data 119.

The system 101 further comprises a computing unit 125. The computing unit 125 comprises an artificial intelligence 127 for forecasting a future signal pattern based on the traffic data 105.

There is provision here for the artificial intelligence 127 to be trained using the traffic data 105 and also the signal pattern data 119.

The system 101 further comprises a third communications interface 129, which sends the signal pattern data corresponding to the forecast signal pattern to a motor vehicle 131 over a communication network. The motor vehicle 131 has a terminal (not shown) to which a network address is assigned.

According to one form of embodiment there is provision for the artificial intelligence 127 to have a signal pattern forecasting model, on the basis of which the future signal pattern is forecast by using the traffic data.

The signal pattern forecasting model is trained for example on the basis of the traffic data and the signal pattern data of the light signal system.

FIG. 2 shows a flow diagram of a method for forecasting a future signal pattern of a light signal system.

The method comprises the following:
Receipt 201 of traffic data for a light signal system, on the basis of which the light signal system can establish a future signal pattern, in order to display the signal pattern established,
Receipt 203 of the signal pattern data of the light signal system corresponding to the signal pattern established by means of the light signal system,
Forecasting 205 of a future signal pattern on the basis of the traffic data by means of a computing unit comprising an artificial intelligence,
wherein the artificial intelligence will be trained 207 on the basis of the traffic data and the signal pattern data of the light signal system.

The inventive concept is based on the use of artificial intelligence to forecast a future signal pattern of a light signal system. The artificial intelligence comprises a neural network for example. For example a machine-learning algorithm is implemented in the artificial intelligence. The term machine learning is also known by the term deep learning.

It is thus made possible in an advantageous manner, in a traffic-dependent light signal system for example, i.e. in a light signal system of which the signal patterns are controlled as a function of traffic, wherein a programming and a supply of the light signal system are not known, for a future signal pattern of the light signal system to be able to be forecast in an efficient manner.

For example the light signal system is logically connected to a number of detectors. For example there is provision for the system for forecasting a future signal pattern of a light signal system also to be logically connected to the same detectors.

Thus the artificial intelligence receives the same data as the light signal system. Furthermore the artificial intelligence also receives an output of the light signal system, i.e. the signal pattern established by means of the light signal system. The artificial intelligence can thus for example, by using a neural network or by using a machine-learning algorithm respectively, learn a reaction of the light signal system or a behavior of the light signal system respectively, to the extent that it can provide a reliable forecast about a future signal pattern.

Information about the forecast signal pattern can be communicated for example to drivers of motor vehicles and/or to road users.

The inventive concept thus makes it possible for the future signal patterns of light signal systems to be forecast efficiently and reliably. Based on these forecast signal patterns for example a traffic flow can be controlled efficiently in an advantageous manner, which for example can enhance driving efficiency or driving safety respectively, for example because less fuel will be used or fewer pollutants or exhaust gases, for example carbon dioxide, will be emitted.

Furthermore the information about the forecast signal pattern can also be used for navigation. For example a travel route can be forecast even more precisely if it is reliably known how a future signal pattern of a light signal system will look.

In an advantageous manner the inventive concept does not have to take account of system-specific or manufacturer-specific peculiarities of a light signal system. An existing control logic and programming of a light signal system are not relevant, since only the real input parameters (traffic data) and the real output parameters (signal pattern established, i.e. signal pattern data of the light signal system) are used for the training of the artificial intelligence, in particular for the training of the signal pattern forecast model.

For example the system is embodied as a separate module or can be operated as such a model respectively, which is compatible for example with a plurality of light signal system control devices, which in an advantageous manner makes possible a simple city-wide or country-wide scaling respectively.

As technical means for application of an artificial intelligence there are various frameworks available for example. Thus for example Google (TensorFlow), Microsoft (Azure ML) or IBM (Watson) each provide an environment in which, by means of neural networks, models, i.e. here in particular signal pattern forecast models, can be trained and applied or used respectively.

In accordance with one form of embodiment the system is embodied as an autonomous module, which for example can be implemented or connected via standardized interfaces to a control facility (which is a control device for example) of the light signal system. This thus means that, according to one form of embodiment, the system is connected for example to a control facility of a light signal system. The first or the second communications interface respectively are used in particular for this connection.

Thus the inventive concept can be sold to cities and communities in an advantageous manner for example.

For example there is provision for the artificial intelligence of for the computing unit respectively to be part of a Cloud infrastructure.

This thus means that, in accordance with one form of embodiment, the traffic data and the signal pattern data of the light signal system are sent to a Cloud infrastructure, wherein then the artificial intelligence, which is part of this Cloud infrastructure, is trained in accordance with the statements made above and forecasts a future signal pattern in accordance with the information given here.

The signal pattern data corresponding to the forecast signal pattern can be made available for example to motor vehicle manufacturers or motor vehicle suppliers, who then send this data to their motor vehicles, so that this can then be displayed for each vehicle, which can for example be sold or purchased respectively as a convenience function.

The inventive concept thus makes possible in an advantageous manner a self-learning forecast of a future signal pattern of a light signal system using only the traffic data and the signal pattern data of the light signal system. Any control methods that are implemented in the light signal system are not required for the inventive concept. Knowledge of these methods is thus not necessary.

Although the invention has been illustrated and described in greater detail by the preferred exemplary embodiments, the invention is not restricted by the disclosed examples and other variations can be derived herefrom by the person skilled in the art, without departing from the scope of protection of the invention.

1. A system for forecasting a future signal pattern of a light signal system, the system comprising:
a first communications interface for receiving traffic data for a light signal system, wherein the light signal system is enabled to establish a future signal pattern based on the traffic data, in order to display the signal pattern thus established;
a second communications interface for receiving corresponding signal pattern data of the light signal system from the signal pattern established by the light signal system; and
a computing unit containing a trainable artificial intelligence to be trained on a basis of the traffic data and the signal pattern data of the light signal system and for forecasting a future signal pattern based on the traffic data.

2. The system according to claim 1, wherein said artificial intelligence comprises a neural network.

3. The system according to claim 1, wherein a machine-learning algorithm is implemented in the artificial intelligence.

4. The system according to claim 1, wherein said artificial intelligence forms a part of a cloud infrastructure.

5. The system according to claim 1, further comprising a third communications interface for sending the signal pattern data corresponding to the forecast future signal pattern to a network address over a communication network.

6. A method of forecasting a future signal pattern of a light signal system, the method comprising the following steps:
receiving traffic data for a light signal system, wherein the light signal system is enabled to establish a future signal pattern based on the traffic data, in order to display the signal pattern thus established;
receiving signal pattern data of the light signal system corresponding to the signal pattern established by way of the light signal system;
forecasting a future signal pattern on a basis of the traffic data by a computing unit containing an artificial intelligence; and
training the artificial intelligence on a basis of the traffic data and the signal pattern data of the light signal system.

7. The method according to claim 6, wherein the artificial intelligence comprises a neural network.

8. The method according to claim 6, which comprises implementing a machine-learning algorithm in the artificial intelligence.

9. The method according to claim 6, wherein the artificial intelligence is part of a Cloud infrastructure.

10. The method according to claim 6, which further comprises sending the signal pattern data corresponding to the forecast future signal pattern to a network address over a communication network.

11. A computer program, comprising program code in non-transitory form for carrying out the method according to claim 6, when the computer program is executed on a computer.

12. The computer program according to claim 11, wherein the program code is configured for a computing unit including artificial intelligence.

13. A computer program product, comprising computer-readable program code stored in non-transitory form for carrying out the method according to claim 6 when the program code is read into a memory of a computing unit having artificial intelligence.
